(19) United States
(12) Patent Application Publication
(10) Pub. No.: US 2026/0093933 A1
(43) Pub. Date: Apr. 2, 2026

(54) METHOD, APPARATUS, DEVICE, AND MEDIUM FOR PROCESSING A USER REQUEST

(71) Applicants: Lemon Inc., Grand Cayman (KY); Beijing Youzhuju Network Technology Co., Ltd., Pinggu District, Beijing (CN)

(72) Inventors: Yukun Ma, VANCOUVER (CA); Yingtong Bu, Beijing (CN); Huan Liang, Beijing (CN)

(21) Appl. No.: 19/103,395

(22) PCT Filed: Mar. 27, 2024
(86) PCT No.: PCT/CN2024/084226

§ 371 Date: Feb. 12, 2025

(51) Int. Cl. G06F 40/40

(52) U.S. Cl. CPC G06F 40/40

(57) ABSTRACT

A method, an apparatus, a device, and a medium for processing a user request are provided. In the method, in response to receiving the user request, a reference prompt matching the user request is determined; a set of reference samples matching the user request is determined, wherein a reference sample in the set of reference samples comprises a reference user request and a reference response for the reference user request, and a task type specified by the user request is the same as a reference task type specified by the reference user request; and a prompt for executing the user request is generated based on the user request, the reference prompt, and the set of reference samples.

### FIELD

Example implementations of the present disclosure generally relate to computer technologies, and in particular, to a method, an apparatus, a device, and a computer-readable storage medium for processing a user request.

### BACKGROUND

Few-shot problem refers to a machine learning problem with few samples available during model training. For example, usually in a service, only a small amount of data may be collected for a certain category of data, making it difficult for a model to learn a pattern therefrom. A conventional machine learning algorithm, especially a deep learning algorithm, usually requires a large amount of labeled training data to learn patterns and extract features therefrom, therefore the few-shot problem poses a challenge for the establishment of machine learning models. In such cases, it is desirable to address the problem in few shot scenarios.

### SUMMARY

In a first aspect of the present disclosure, a method for processing a user request is provided. The method includes: in response to receiving the user request, determining a reference prompt matching the user request; determining a set of reference samples matching the user request, where a reference sample in the set of reference samples includes a reference user request and a reference response for the reference user request, and a task type specified by the user request is the same as a reference task type specified by the reference user request; and generating a prompt for executing the user request based on the user request, the reference prompt, and the set of reference samples.

In a second aspect of the present disclosure, an apparatus for processing a user request is provided. The device includes a reference prompt determining module configured to, in response to receiving the user request, determine a reference prompt matching the user request; a reference sample determining module configured to determine a set of reference samples matching the user request, where a reference sample in the set of reference samples includes a reference user request and a reference response for the reference user request, and a task type specified by the user request is the same as a reference task type specified by the reference user request; and a prompt generating module configured to generate a prompt for executing the user request based on the user request, the reference prompt, and the set of reference samples. The apparatus further includes other modules configured to implement other steps in the method described above.

In a third aspect of the present disclosure, an electronic device is provided. The electronic device includes: at least one processing unit; and at least one memory coupled to the at least one processing unit and storing instructions for execution by the at least one processing unit, the instructions, when executed by the at least one processing unit, causing the electronic device to perform the method according to the first aspect of the present disclosure.

In a fourth aspect of the present disclosure, there is provided a computer-readable storage medium having stored thereon a computer program which, when executed by a processor, causes the processor to implement the method according to the first aspect of the present disclosure.

It should be understood that the content described in this summary is not intended to limit key features or important features of implementations of the present disclosure, nor is it intended to limit the scope of the present disclosure. Other features of the present disclosure will become readily understood from the following description.

### BRIEF DESCRIPTION OF DRAWINGS

The above and other features, advantages, and aspects of the various implementations of the present disclosure will become more apparent from the following detailed description taken in combination with the accompanying drawings. In the drawings, the same or similar reference numbers refer to the same or similar elements, where:

FIG. 1 illustrates a schematic diagram of an example environment in which implementations of the present disclosure can be implemented;

FIG. 2 shows a schematic diagram for processing a user request according to some implementations of the present disclosure;

FIG. 3 illustrates an example data structure of a reference sample library according to some implementations of the present disclosure;

FIG. 4 shows a schematic diagram of searching a set of reference samples according to some implementations of the present disclosure;

FIG. 5 illustrates an example data structure of a reference prompt library according to some implementations of the present disclosure;

FIG. 6 shows a schematic diagram of generating a response based on a prompt according to some implementations of the present disclosure;

FIG. 7 shows another schematic diagram of generating a response based on a prompt according to some implementations of the present disclosure;

FIG. 8 shows a flowchart of a method for processing a user request according to some implementations of the present disclosure;

FIG. 9 shows a block diagram of an apparatus for processing a user request according to some implementations of the present disclosure; and

FIG. 10 illustrates a block diagram of a device capable of implementing various implementations of the present disclosure.

### DETAILED DESCRIPTION

Implementations of the present disclosure will be described in more detail below with reference to the accompanying drawings. While certain implementations of the present disclosure are shown in the accompanying drawings, it should be understood that the present disclosure may be implemented in various forms and should not be construed as limited to the implementations set forth herein, but rather, these implementations are provided for a more thorough and complete understanding of the present disclosure. It should be understood that the drawings and implementations of the present disclosure are for illustrative purposes only and are not intended to limit the scope of the present disclosure.

In the description of implementations of the present disclosure, the terms “include/comprise” and similar terms should be understood to include “including/comprising but not limited to”. The term “based on” should be understood as “based at least in part on”. The terms “one implementation” or “the implementation” should be understood as “at least one implementation”. The term “some implementations” should be understood as “at least some implementations”. Other explicit and implicit definitions may also be included below. As used herein, the term “model” may represent an association between various data. For example, the association may be obtained based on various technical solutions currently known and/or to be developed in the future.

It may be understood that the data involved in the technical solution (including but not limited to the data itself, the acquisition or use of the data) should follow the requirements of the corresponding laws and regulations and related provisions.

It can be understood that, before the technical solutions disclosed in the implementations of the present disclosure are used, the types of personal information, the usage scope, the usage scenario, and the like related to the present disclosure should be notified to the user and the authorization of the user should be obtained in an appropriate manner according to the relevant laws and regulations.

For example, in response to receiving an active request from a user, prompt information is sent to the user to explicitly prompt the user that the requested operation will need to acquire and use the personal information of the user. Therefore, the user can autonomously select whether to provide personal information to software or hardware executing the operation of the technical solution of the present disclosure according to the prompt information.

As an optional but non-limiting implementation, in response to receiving an active request from the user, a manner of sending prompt information to the user may be, for example, a pop-up window, and prompt information may be presented in a text manner in the pop-up window. In addition, the pop-up window may further carry a selection control for the user to select “agree” or “disagree”to provide personal information to the electronic device.

It may be understood that the foregoing notification and obtaining a user authorization process is merely illustrative, and does not constitute a limitation on implementations of the present disclosure, and other manners of meeting related laws and regulations may also be applied to implementations of the present disclosure.

The term “in response to” as used herein means a state in which a respective event occurs or condition is satisfied. It will be appreciated that the timing of execution of a subsequent action performed in response to the event or condition is not necessarily strongly correlated with the time at which the event occurs or the condition holds. For example, in some cases, subsequent actions may be performed immediately when an event occurs or a condition holds; while in other cases, subsequent actions may be performed after a period of time elapses after an event occurs or a condition holds.

### Example Environment

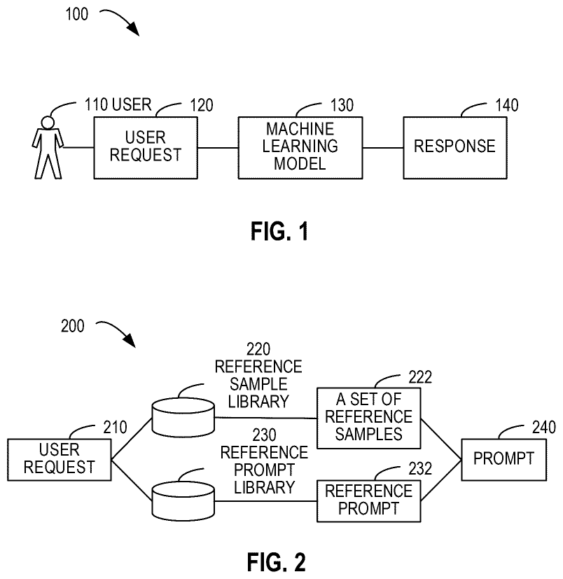

As mentioned above, in a few-shot scenario, it is difficult for a model to learn a pattern therefrom. For ease of description, the environment of FIG. 1 is taken as an example to describe the few-shot problems in machine learning. FIG. 1 illustrates a schematic diagram of an example environment 100 in which implementations of the present disclosure can be implemented. In the example environment 100, a user 110 may input a user request 120 into a machine learning model 130. Based on the user request 120, the machine learning model 130 may return a response 140 to the user 110.

In some example implementations, the user request 120 may include a request for text classification, object detection, voice recognition, and the like. The machine learning model 130 returns the corresponding response 140 based on the type of the user request 120.

In some example implementations, the machine learning model 130 may be trained with samples that perform different tasks, and multiple tasks may be performed. In the following, a language model will be described as an example of the machine learning model 130. For example, the machine learning model 130 may perform task 1 and task 2, respectively, based on different user requests received. The task 1 relates to a large sample, and in the training stage, the machine learning model 130 can extract features and learn the pattern according to a large amount of labeled data, so that the machine learning model 130 has a better performance when executing the task 1. The task 2 involves a small sample, and in the training stage, the machine learning model 130 is difficult to learn the underlying pattern, resulting in poor performance of the machine learning model 130 when executing the task 2.

Traditionally, methods to address few-shot learning include meta-learning, transfer learning, data augmentation, and self-supervised learning.

The idea of meta-learning is to design an algorithm to understand the learning process itself, so that the model learns how to quickly and effectively adapt to new tasks. Typical meta-learning methods include model-agnostic meta-learning (MAML) and the like. While meta-learning can quickly adapt to new tasks with few training samples, designing and implementing efficient meta-learning algorithms may be complex. Certain meta-learning algorithms require specific training settings, which may not be readily implemented in practical applications.

Transfer learning is to exploit knowledge learned in one relevant domain (source domain), and apply to a different, but relevant domain (target domain) to resolve problems. When processing the few-shot problem, this approach first pretrains a model on big data, and then fine-tunes the model on fewer sample tasks. Although the transfer learning may utilize the information in the source task to improve the task performance of the target task, the effect of the transfer learning may not be ideal if the correlation between the source task and the target task is not high. In addition, the pretrained model may be excessively complex and cannot achieve efficiency optimization on certain tasks. Moreover, the correlation between the target task and the source task in a few-shot scenario is typically difficult to predict in advance.

Data augmentation increases the amount of data by making small changes to the original data, such as rotating, scaling, clipping images, or the like. Although data augmentation improves the generalization performance of the model by expanding the training dataset, data augmentation requires human design and selection of a suitable data transformation approach, which requires expertise and may consume a significant amount of time. Furthermore, in some cases, excessive data augmentation may introduce noise and instead affect the performance of the model.

The self-supervised learning enables the model to generate labels for learning by itself by setting up a prediction task (for example, predicting a next frame, a next word, or the like), thereby avoiding relying on a large amount of manually labeled data. Although the self-supervised learning may make full use of unlabeled data by setting up a prediction task by itself for learning, the self-supervised learning requires a design of a proper prediction task to drive the model to learn a useful representation, and the design process may require expertise and experience. In general, models need to be trained for different few-shot scenarios to accommodate such tasks, which takes a long period.

Based on the above methods for solving the few-shot problem, it can be known that implementations of most of the existing solutions require further training of the model, or careful design of data or model, which is costly. In few-shot tasks and content recognition problems with variable and unpredictable data, it is unacceptable to adjust the model for every new type of few-shot task that arises.

In-context learning (ICL) is a learning method that refers to obtaining knowledge and skills in a particular environment or context. This approach emphasizes that knowledge is obtained and mastered from a practical situation that is closely related to an actual living environment and experience of a learner. In the field of artificial intelligence and machine learning, ICL focuses on enabling the model to understand and use in-context information. This is implemented by having the model attentive to the environment, background, or other information related thereto when the model processes the input information. For example, in natural language processing, the meaning of various words and phrases may be affected by the context. The ICL enables the model to understand and adapt to different contexts to understand and predict the language more accurately.

“ICL capability” refers to the ability to learn from experience and practice in a particular context or environment. For example, in a language model, because it possesses more parameters, it means that they have greater tolerance and deeper complexity, all of which are required to understand and process complex tasks. This includes the ability to understand and use in-context information, that is, the ICL capability. Specifically, the following several reasons will allow the model to have the capability of ICL.

A deeper network layer allows the model to have the capability of ICL. Language models are composed of more neural network layers, allowing them to learn and represent more complex, more abstract features and patterns. This capability enables them to understand and use more complex in-context information. More parameters also allow the model to have the capability of ICL. Due to more parameters, the language model can learn more diverse data representations. This allows them learn how to better understand the task using context when processing data with context. In addition, adaptability to few-shot also enables the model to have the capability of ICL. Language models can be efficiently learned and generalized from small samples due to their depth and width, which is a key to the in-context learning. At this point, it is desirable to utilize the ICL capability of the model to provide a more accurate response.

### Summary to Solve the Few-shot Problem

In order to at least partially solve the deficiencies in the prior art, a method for processing a user request is provided according to an example implementation of the present disclosure. Based on the above considerations, the present disclosure proposes to directly leverage the learning capabilities of ICL in language models, transforming the conventional content recognition problem into system modules for retrieval, context learning, and identification, thereby addressing the issue of content recognition with few-shot.

FIG. 2 shows a schematic diagram according to an example implementation of the present disclosure, and FIG. 2 shows a schematic diagram 200 for processing a user request according to some example implementations of the present disclosure. As shown in FIG. 2, in response to receiving a user request 210, a reference prompt 232 matching the user request 210 is determined. A set of reference samples 222 matching the user request 210 is determined. A reference sample in the set of reference samples 222 includes a reference user request and a reference response for the reference user request, and a task type specified by the user request 210 is the same as a reference task type specified by the reference user request. A prompt 240 for executing the user request 210 is generated based on the user request 210, the reference prompt 232, and the set of reference samples 222.

With the example implementation of the present disclosure, the reference prompt and the reference sample that are pre-verified as accurate and reliable may be directly used, and the prompt for executing the user request may be generated by determining the reference prompt and the set of reference samples that match the user request without model training. Further, a more accurate response may be obtained based on the prompt, thereby reducing the complexity of training and fine-tuning the machine learning model, and enabling the machine learning model to output a more accurate response.

### Detailed Process to Solve the Few-shot Problem

In some example implementations, the technical solution according to an example implementation of the present disclosure may be invoked only in the few-shot scenario. Specifically, in response to determining that the number of samples associated with the task type is less than a predetermined threshold, the method for processing a user request provided by the example implementation of the present disclosure is performed. When performing few-shot related tasks, this approach may be used to address the few-shot problem since it is difficult to learn patterns from few samples (for example, less than 10 or another amount of data). The predetermined threshold herein may be 5, 10, or the like, which is not limited in this application. By utilizing the example implementation of the present disclosure, the method may be implemented when performing a task related to a small sample, and the processing capability of the machine learning model is improved by generating a more accurate prompt.

With continued reference to FIG. 2, in some example implementations, the reference prompt 232 may be selected from a reference prompt library 230 comprising a plurality of sample prompts, and the reference prompt library 230 is generated based on a prompt associated with the task type. Here, the prompt associated with the task type is a prompt that has been verified as correct and valid. Corresponding reference prompts for different few-shot tasks may be the same or different. Generally, an efficient prompt may be designed for each type of task, so that the problem-solving effect on the type of task is optimal.

The configuration of the prompts may include, for example, a prompt screening and verification step, in this step, since there may be a plurality of prompts for each type of task, manual screening and verification are required, and a prompt template used on each type of task is confirmed. For example, each reference prompt may correspond to a task type, for example, may include: identifying a type of a school involved in the text (for example, an elementary school, a secondary school, a university, or the like), identifying a type of an object in an image, and the like.

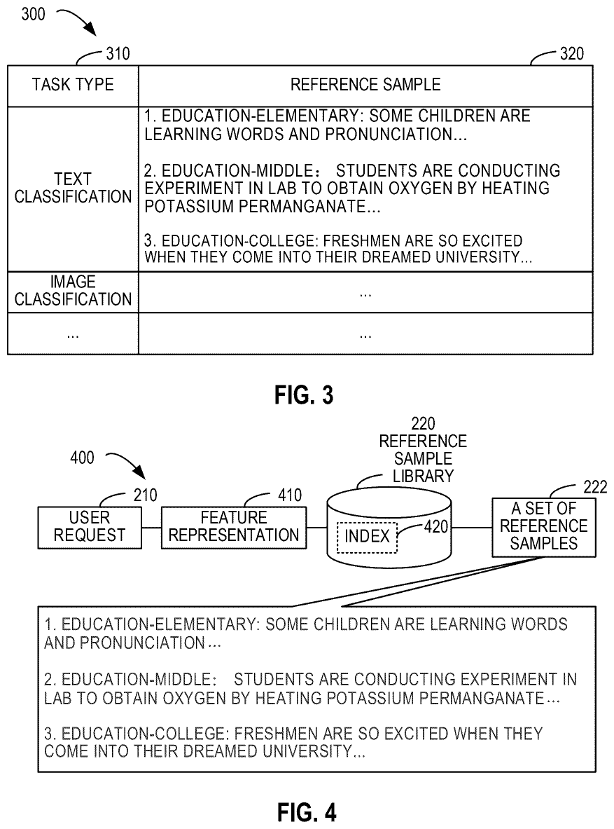

In some example implementations, the set of reference samples 222 may be determined from a reference sample library 220 comprising a plurality of reference samples, and the reference sample library 220 is generated based on samples associated with a task type. Here, the samples associated with the task type are samples that have been verified as correct and valid. The reference sample library 220 will be described below with reference to FIG. 3, which shows an example data structure 300 of the reference sample library 220 according to some implementations of the present disclosure. As shown in FIG. 3, the example data structure 300 may include a task type 310 and a reference sample 320. For example, the task type 310 may include text classification, image classification, voice classification, and the like. The reference sample 320 corresponding to the text classification task may include samples that classify different texts into different school types, which may include, for example, the following classifications:

“1. Education-Elementary: some children are learning words and pronunciation.”. “2. Education-Middle: students are conducting experiment in lab to obtain oxygen by heating potassium permanganate.”. “3. Education-College: freshmen are so excited when they come into their dreamed university.”.

It should be understood that although specific tasks of text classification are described above in English as an example of a natural language, alternatively, and/or in addition, text may be written in other languages such as Chinese, French, Japanese, and the like. In some example implementations, the reference sample 320 corresponding to image classification tasks may include samples that classify different images into different animal types, for example, some images may be classified as dogs, others may be classified as cats, or the like.

The role of the reference sample library 220 is to provide online content management and retrieval such that the magnitude of the library is maintained in a controllable range and contains as many critical tasks as possible. In some example implementations, when designing the reference sample library 220, the critical tasks may first be selected, that is, the critical tasks learned by the machine learning model are specified. These tasks should be the actual problems that the model may encounter during future processing, and these tasks may be customized for inclusion in the library or automatically added into the library.

Next, for each critical task, some samples for expressing the task may be collected. Such samples should contain enough information to resolve the task, but their quantity is much smaller compared to traditional large-scale datasets. These samples may be created autonomously or obtained from online tasks after manual review. Each sample is then converted into a suitable form according to input requirements of the model. For example, if the type of school needs to be identified from text, at least the text and the corresponding type need to be added as basic information, and the text needs to be preprocessed appropriately, so that the input format of the model is consistent.

With the example implementation of the present disclosure, there is no need for model training, and a more accurate prompt 240 is generated by selecting the reference prompt 232 and the set of reference samples 222 from the reference prompt library 230 and the reference sample library 220 that have been verified as correct, thereby more efficiently identifying the content. Further, the machine learning model may better identify unseen data or tasks based on the samples, and improve the generalization ability of the model.

The search for the set of reference samples 222 from the reference sample library 220 is described below with reference to FIG. 4. FIG. 4 shows a schematic diagram 400 of searching the set of reference samples 222 according to some implementations of the present disclosure. In some example implementations, as shown in FIG. 4, a feature representation 410 of the user request 210 may be obtained, and the reference sample library 220 is searched for the set of reference samples 222 matching the feature representation 410, using the feature representation 410. For example, the feature representation 410 of the user request 210 may be an embedding of the user request 210, and after the feature representation 410 is obtained, distances between the feature representation 410 and feature representations of the plurality of reference samples in the reference sample library 220 may be determined, and these distances are sorted in an ascending order to determine k reference samples with the smallest distance (that is, top k nearest samples). Alternatively, and/or in addition, an index of the reference sample library 220 may be used to speed up searching the set of reference samples 222. With an example implementation of the present disclosure, a reference sample approximate to the feature representation of the user request 210 may be determined from the reference sample library 220, thereby generating a more accurate prompt 240.

In some example implementations, the set of reference samples 222 may be determined using an index 420 of the reference sample library 220, and the index is created based on the plurality of reference samples in the reference sample library 220. An indexing system may be created based on the content in the library and the corresponding embeddings, such that the corresponding few-shot (that is, the set of reference samples 222) can be found quickly during retrieval. The retrieval method herein may retrieve in any manner, not limited to being retrieved in an embedded manner, and the retrieval method is also not limited to Faiss, Annoy, NMSLIB, nearest neighbor algorithm of Scikit-learn, and BallTree and KDTree in SciPy. With example implementations of the present disclosure, the retrieval process may be accelerated, and the set of reference samples 222 may be quickly determined in the reference sample library 220. By fully utilizing the reference sample library 220 and performing context learning on the model based on the retrieval, the content recognition rate can be improved.

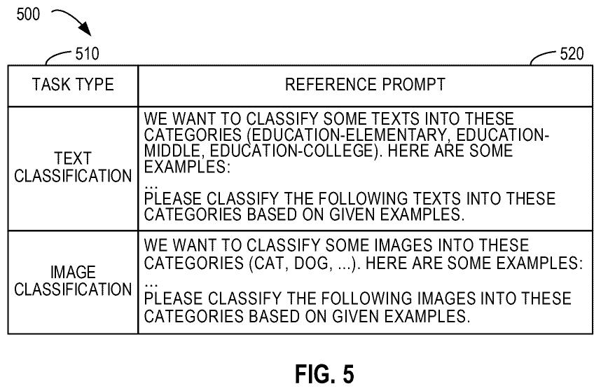

In some example implementations, the reference prompt may be updated using the set of reference samples. The configuration of prompts may further include the configuration of prompts and assembly step, and in this step, after the prompt of each type of task is designed, it needs to be assembled with the retrieved few-shot. The updating of the reference prompt using the set of reference samples is described below with reference to FIG. 5, which shows an example data structure 500 of the reference prompt library 230 according to some implementations of the present disclosure. In the example data structure 500, a reference prompt 520 may be updated using the set of reference samples. In an example, for a set of reference samples of the text classification task in a task type 510, different texts are classified into different school categories, the reference prompt 520 may be updated as:

“We want to classify some texts into these categories (Education-Elementary, Education-Middle, Education-College). Here are some examples: . . . Please classify the following texts into these categories based on given examples.

In another example, for a set of reference samples of the image classification task in the task type 510, different images are classified into different animal categories, and the reference prompt 520 may be updated as:

“We want to classify some images into these categories (cat, dog, . . .) . Here are some examples: . . . Please classify the following images into these categories based on given examples.

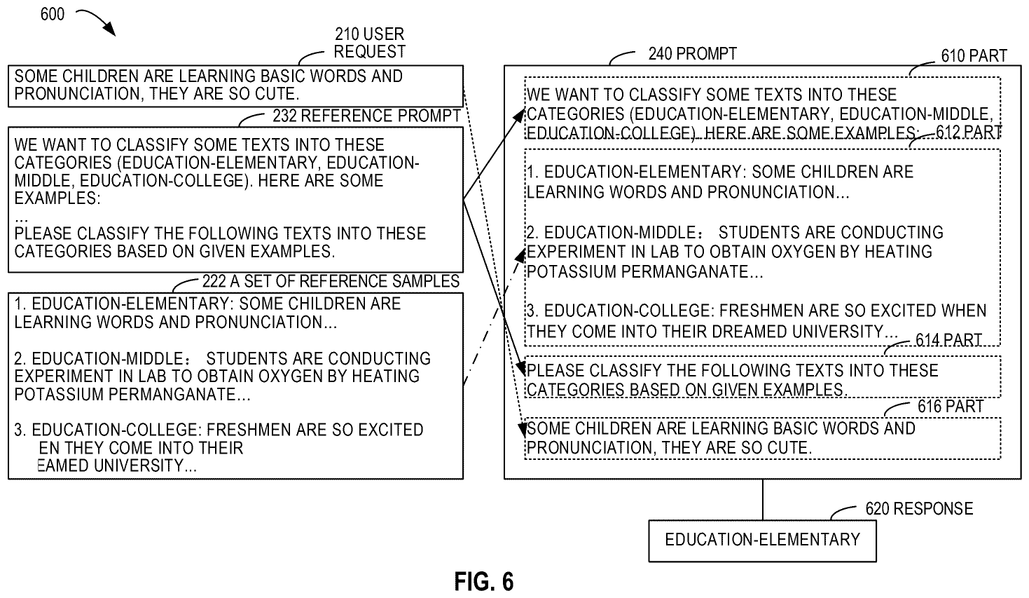

In some example implementations, the updated reference prompt and the user request may be combined to generate the prompt. The combination of the updated reference prompt and the user request to generate the prompt is described below with reference to FIG. 6, which shows a schematic diagram 600 of generating a response based on a prompt according to some implementations of the present disclosure. As shown in FIG. 6, the user request 210, the reference prompt 232, and the set of reference samples 222 may be combined to generate the prompt 240. At this time, the user request 210 corresponds to a part 616 in the prompt 240, the reference prompt 232 corresponds to a part 610 and a part 614 in the prompt 240, and the set of reference samples 222 corresponds to a part 612 in the prompt 240. According to the example implementation of the present disclosure, by combining the updated reference prompt and the user request into the prompt, the environment and the task may be dynamically updated, thereby improving the ability to handle dynamic changes and uncertainties in actual problems.

In some example implementations, a language processing model may be utilized to generate a response to the user request based on the prompt. The language processing model herein is a model with context learning capability, and is not limited to various language models, for example, may include multiple language models known in the past and/or will be developed in the future. With continued reference to FIG. 6, the combined prompt 240 is input into the language processing model, and the language processing model may output a response 620. In the example of FIG. 6, the user request 210 is “some children are learning basic words and pronunciation, they are so cute”, the response 620 to the user request 210 is “Education-Elementary”.

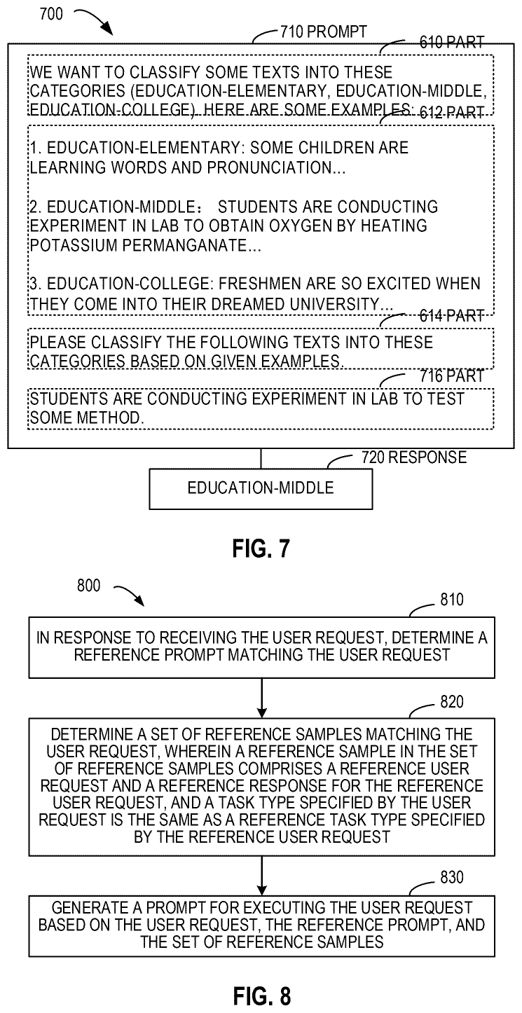

FIG. 7 shows another schematic diagram 700 of generating a response based on a prompt according to some implementations of the present disclosure. As shown in FIG. 7, in a prompt 710, the user request corresponds to a part 716, and the part 716 is “students are conducting experiment in lab to test some method”, a response 720 to the user request is “Education-Middle”. By utilizing the example implementation of the present disclosure, the language processing model generates a more accurate response which better satisfies the user request.

In some example implementations, a sample is created based on the user request and the response, and the sample includes the user request and the response. The sample is added to the reference sample library. According to the example implementation of the present disclosure, the created sample is added into the reference sample library, so that the task diversity of the reference sample library can be improved, so that the content of the reference sample library keeps updating, and the online critical tasks and patterns are continuously captured and covered.

In some example implementations, the index of the reference sample library may be updated using the sample. With the example implementation of the present disclosure, by updating the index of the reference sample library, it can be ensured that the index matches the updated reference sample library, and then the search is performed at a faster speed.

In some example implementations, the language processing model supports multimodal processing and in-context learning, and the multimodal processing includes processing for at least one of: text, image, audio, or video. For example, the language processing model may support text to text (Text2Text, that is, input text, generate text), image to text (Image2Text, that is, input text and image, generate text), and text to image (Text2Image, that is, input text generate image), or the like. According to the example implementation of the present disclosure, the language processing model having the in-context learning capability may support processing of the multimodal data, thereby improving generalization of the language processing model.

### Example Process

FIG. 8 shows a flowchart of a method 800 for processing a user request according to some implementations of the present disclosure. At block 810, in response to receiving the user request, a reference prompt matching the user request is determined. At block 820, a set of reference samples matching the user request is determined, where a reference sample in the set of reference samples includes a reference user request and a reference response for the reference user request, and a task type specified by the user request is the same as a reference task type specified by the reference user request. At block 830, a prompt for executing the user request is generated based on the user request, the reference prompt, and the set of reference samples.

In some example implementations, the method 800 further includes: in response to determining that the number of samples associated with the task type is less than a predetermined threshold, performing the method.

In some example implementations, determining the reference prompt includes: selecting the reference prompt from a reference prompt library comprising a plurality of sample prompts, the reference prompt library generated based on a prompt associated with the task type; and where determining the set of reference samples includes: determining the set of reference samples from a reference sample library comprising a plurality of reference samples, the reference sample library generated based on samples associated with the task type.

In some example implementations, determining the set of reference samples includes: obtaining a feature representation of the user request; and searching, using the feature representation, the reference sample library for the set of reference samples matching the feature representation.

In some example implementations, searching the reference sample library for the set of reference samples includes: determining the set of reference samples using an index of the reference sample library, the index created based on the plurality of reference samples in the reference sample library.

In some example implementations, generating the prompt includes: updating the reference prompt using the set of reference samples; and combining the updated reference prompt and the user request to generate the prompt.

In some example implementations, the method 800 further includes: generating, using a language processing model, a response to the user request based on the prompt.

In some example implementations, the method 800 further includes: creating a sample based on the user request and the response, the sample comprising the user request and the response; and adding the sample to the reference sample library.

In some example implementations, the method 800 further includes: updating, using the sample, the index of the reference sample library.

In some example implementations, the language processing model supports multimodal processing and in-context learning, and the multimodal processing includes processing for at least one of: text, image, audio, or video.

### Example Apparatus and Device

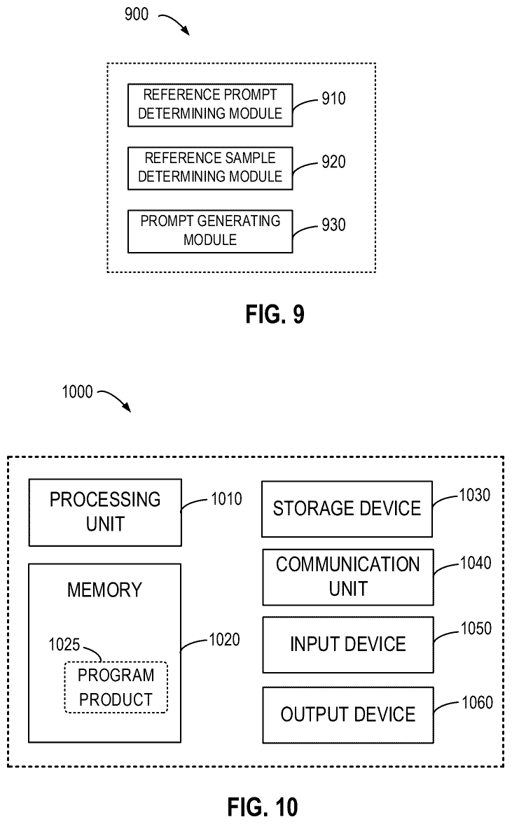

FIG. 9 shows a block diagram of an apparatus 900 for processing a user request according to some implementations of the present disclosure. The apparatus 900 includes: a reference prompt determining module 910 configured to, in response to receiving the user request, determine a reference prompt matching the user request; a reference sample determining module 920 configured to determine a set of reference samples matching the user request, where a reference sample in the set of reference samples includes a reference user request and a reference response for the reference user request, and a task type specified by the user request is the same as a reference task type specified by the reference user request; and a prompt generating module 930 configured to generate a prompt for executing the user request based on the user request, the reference prompt, and the set of reference samples.

In some example implementations, the apparatus 900 is invoked in response to determining that the number of samples associated with the task type is less than a predetermined threshold.

In some example implementations, the reference prompt determining module 910 further includes a reference prompt selecting module configured to select the reference prompt from a reference prompt library comprising a plurality of sample prompts, the reference prompt library generated based on a prompt associated with the task type; and the reference sample determining module 920 further includes a reference sample selecting module configured to determine the set of reference samples from a reference sample library comprising a plurality of reference samples, the reference sample library generated based on samples associated with the task type.

In some example implementations, the reference sample determining module 920 further includes an index utilization module configured to determine the set of reference samples using an index of the reference sample library, the index created based on the plurality of reference samples in the reference sample library.

In some example implementations, the prompt generating module 930 further includes a combining module configured to update the reference prompt using the set of reference samples; and combine the updated reference prompt and the user request to generate the prompt.

In some example implementations, the apparatus 900 further includes a response generating module configured to generate, using a language processing model, a response to the user request based on the prompt.

In some example implementations, the apparatus 900 further a sample adding module configured to create a sample based on the user request and the response, the sample comprising the user request and the response; and adding the sample to the reference sample library.

In some example implementations, the apparatus 900 further includes an index updating module configured to update, using the sample, the index of the reference sample library.

In some example implementations, the language processing model supports multimodal processing and in-context learning, and the multimodal processing includes processing for at least one of: text, image, audio, or video.

FIG. 10 illustrates a block diagram of a device 1000 capable of implementing various implementations of the present disclosure. It should be understood that the computing device 1000 shown in FIG. 10 is merely an example and should not constitute any limitation on the functionality and scope of the implementations described herein. The computing device 1000 shown in FIG. 10 may be configured to implement the method described above.

As shown in FIG. 10, the computing device 1000 is in the form of a general-purpose computing device. Components of the computing device 1000 may include, but are not limited to, one or more processors or processing units 1010, a memory 1020, a storage device 1030, one or more communication units 1040, one or more input devices 1050, and one or more output devices 1060. The processing unit 1010 may be an actual or virtual processor and capable of performing various processes according to programs stored in the memory 1020. In multiprocessor systems, multiple processing units execute computer-executable instructions in parallel to improve parallel processing capabilities of the computing device 1000.

The computing device 1000 typically includes a plurality of computer storage medium. Such medium may be any available medium accessible by the computing device 1000, including, but not limited to, volatile and non-volatile medium, removable and non-removable medium. The memory 1020 may be a volatile memory (for example, a register, a cache, a random-access memory (RAM)), a non-volatile memory (for example, a read-only memory (ROM), an electrically erasable programmable read-only memory (EEPROM), a flash memory), or some combination thereof. The storage device 1030 may be a removable or non-removable medium and may include a machine-readable medium, such as a flash drive, a magnetic disk, or any other medium, which may be capable of storing information and/or data (for example, training data for training) and may be accessed within the computing device 1000.

The computing device 1000 may further include additional removable/non-removable, or volatile/non-volatile storage medium. Although not shown in FIG. 10, a disk drive for reading or writing from a removable, nonvolatile magnetic disk (for example, a “floppy disk”) and an optical disk drive for reading or writing from a removable, nonvolatile optical disk may be provided. In these cases, each drive may be connected to a bus (not shown) by one or more data medium interfaces. The memory 1020 may include a computer program product 1025 having one or more program modules configured to perform various methods or actions of various implementations of the present disclosure.

The communication unit 1040 implements communications with other computing devices over a communication medium. Additionally, the functionality of components of the computing device 1000 may be implemented in a single computing cluster or multiple computing machines capable of communicating over a communication connection. Thus, the computing device 1000 may operate in a networked environment using logical connections with one or more other servers, network personal computers (PCs), or another network node.

The input device 1050 may be one or more input devices such as a mouse, a keyboard, a trackball, or the like. The output device 1060 may be one or more output devices, such as a display, a speaker, a printer, or the like. The computing device 1000 may also communicate with one or more external devices (not shown) such as a storage device, a display device, or the like, communicate with one or more devices that enable a user to interact with the computing device 1000, or communicate with any device (for example, network card, modem, or the like) that enables the computing device 1000 to communicate with one or more other computing devices, through the communication unit 1040 as needed. Such communication may be performed via an input/output (I/O) interface (not shown).

According to example implementations of the present disclosure, there is provided a computer-readable storage medium having computer-executable instructions stored thereon, where the computer-executable instructions are executed by a processor to implement the method described above. According to example implementations of the present disclosure, a computer program product is further provided, and the computer program product is tangibly stored on a non-transitory computer-readable medium and comprises computer-executable instructions, the computer-executable instructions are executed by a processor to implement the method described above. According to example implementations of the present disclosure, there is provided a computer program product having stored thereon a computer program, which when executed by a processor, implements the method described above.

Aspects of the present disclosure are described herein with reference to flowcharts and/or block diagrams of methods, apparatuses, devices, and computer program products implemented in accordance with the present disclosure. It should be understood that each block of the flowchart and/or block diagram, and combinations of blocks in the flowcharts and/or block diagrams, may be implemented by computer readable program instructions.

These computer-readable program instructions may be provided to a processing unit of a general-purpose computer, special purpose computer, or other programmable data processing device to produce a machine, such that the instructions, when executed by a processing unit of a computer or other programmable data processing device, produce means to implement the functions/acts specified in the flowchart and/or block diagram. These computer-readable program instructions may also be stored in a computer-readable storage medium that cause the computer, programmable data processing device, and/or other devices to function in a particular manner, such that the computer-readable medium storing instructions includes an article of manufacture including instructions to implement aspects of the functions/acts specified in the flowchart and/or block diagram(s).

The computer-readable program instructions may be loaded onto a computer, other programmable data processing device, or other device, on which a series of operational steps are performed to produce a computer-implemented process, such that the instructions executed on the computer, other programmable data processing device, or other device implement the functions/acts specified in one or more blocks in the flowchart and/or block diagram.

The flowchart and block diagrams in the figures show architecture, functionality, and operation of possible implementations of systems, methods, and computer program products according to various implementations of the present disclosure. In this regard, each block in the flowchart or block diagram may represent a module, program segment, or portion of an instruction that includes one or more executable instructions for implementing the specified logical function. In some alternative implementations, the functions noted in the blocks may also occur in a different order than noted in the figures. For example, two consecutive blocks may actually be performed substantially in parallel, which may sometimes be performed in the reverse order, depending on the functionality involved. It is also noted that each block in the block diagrams and/or flowchart, as well as combinations of blocks in the block diagrams and/or flowchart, may be implemented with a dedicated hardware-based system that performs the specified functions or actions, or may be implemented in a combination of dedicated hardware and computer instructions.

Various implementations of the present disclosure have been described above, which are examples, not exhaustive, and are not limited to the implementations disclosed. Many modifications and variations will be apparent to those of ordinary skill in the art without departing from the scope and spirit of the various implementations illustrated. The selection of the terms used herein is intended to best explain the principles of the implementations, practical applications, or improvements to techniques in the marketplace, or to enable others of ordinary skill in the art to understand the various implementations disclosed herein.

1. A method for processing a user request, comprising:
in response to receiving the user request, determining a reference prompt matching the user request;
determining a set of reference samples matching the user request, wherein a reference sample in the set of reference samples comprises a reference user request and a reference response for the reference user request, and a task type specified by the user request is the same as a reference task type specified by the reference user request; and
generating a prompt for executing the user request based on the user request, the reference prompt, and the set of reference samples.

2. The method of claim 1, further comprising: in response to determining that the number of samples associated with the task type is less than a predetermined threshold, performing the method.

3. The method of claim 1, wherein determining the reference prompt comprises:
selecting the reference prompt from a reference prompt library comprising a plurality of sample prompts, the reference prompt library generated based on a prompt associated with the task type; and
wherein determining the set of reference samples comprises: determining the set of reference samples from a reference sample library comprising a plurality of reference samples, the reference sample library generated based on samples associated with the task type.

4. The method of claim 3, wherein determining the set of reference samples comprises:
obtaining a feature representation of the user request; and
searching, using the feature representation, the reference sample library for the set of reference samples matching the feature representation.

5. The method of claim 4, wherein searching the reference sample library for the set of reference samples comprises: determining the set of reference samples using an index of the reference sample library, the index created based on the plurality of reference samples in the reference sample library.

6. The method of claim 1, wherein generating the prompt comprises:
updating the reference prompt using the set of reference samples; and
combining the updated reference prompt and the user request to generate the prompt.

7. The method of claim 5, further comprising: generating, using a language processing model, a response to the user request based on the prompt.

8. The method of claim 7, further comprising:
creating a sample based on the user request and the response, the sample comprising the user request and the response; and
adding the sample to the reference sample library.

9. The method of claim 8, further comprising: updating, using the sample, the index of the reference sample library.

10. The method of claim 7, wherein the language processing model supports multimodal processing and in-context learning, and the multimodal processing comprises processing for at least one of: text, image, audio, or video.

11. (canceled)

12. An electronic device, comprising:
at least one processing unit; and
at least one memory coupled to the at least one processing unit and storing instructions for execution by the at least one processing unit, the instructions, when executed by the at least one processing unit, causing the electronic device to perform acts comprising:
in response to receiving the user request, determining a reference prompt matching the user request;
determining a set of reference samples matching the user request, wherein a reference sample in the set of reference samples comprises a reference user request and a reference response for the reference user request, and a task type specified by the user request is the same as a reference task type specified by the reference user request; and
generating a prompt for executing the user request based on the user request, the reference prompt, and the set of reference samples.

13. A non-transitory computer-readable storage medium having stored thereon a computer program which, when executed by a processor, causes the processor to perform acts comprising:
in response to receiving the user request, determining a reference prompt matching the user request;
determining a set of reference samples matching the user request, wherein a reference sample in the set of reference samples comprises a reference user request and a reference response for the reference user request, and a task type specified by the user request is the same as a reference task type specified by the reference user request; and
generating a prompt for executing the user request based on the user request, the reference prompt, and the set of reference samples.

14. The electronic device of claim 12, the acts further comprising: in response to determining that the number of samples associated with the task type is less than a predetermined threshold, performing the acts.

15. The electronic device of claim 12, wherein determining the reference prompt comprises: selecting the reference prompt from a reference prompt library comprising a plurality of sample prompts, the reference prompt library generated based on a prompt associated with the task type; and
wherein determining the set of reference samples comprises: determining the set of reference samples from a reference sample library comprising a plurality of reference samples, the reference sample library generated based on samples associated with the task type.

16. The electronic device of claim 15, wherein determining the set of reference samples comprises:
obtaining a feature representation of the user request; and
searching, using the feature representation, the reference sample library for the set of reference samples matching the feature representation.

17. The electronic device of claim 16, wherein searching the reference sample library for the set of reference samples comprises: determining the set of reference samples using an index of the reference sample library, the index created based on the plurality of reference samples in the reference sample library.

18. The electronic device of claim 12, wherein generating the prompt comprises:
updating the reference prompt using the set of reference samples; and
combining the updated reference prompt and the user request to generate the prompt.

19. The electronic device of claim 17, the acts further comprising: generating, using a language processing model, a response to the user request based on the prompt.

20. The electronic device of claim 19, the acts further comprising:
creating a sample based on the user request and the response, the sample comprising the user request and the response; and
adding the sample to the reference sample library.

21. The electronic device of claim 20, the acts further comprising: updating, using the sample, the index of the reference sample library.
